(19) United States
(12) Patent Application Publication
(10) Pub. No.: US 2012/0073092 A1
(43) Pub. Date: Mar. 29, 2012

(54) CLAMPING DEVICE AND METHOD OF CLAMPING

(75) Inventor: Alfred Höbel, Lauben (DE)

(73) Assignee: GROB-WERKE GmbH & Co. KG, Mindelheim (DE)

(21) Appl. No.: 13/237,389

(22) Filed: Sep. 20, 2011

(30) Foreign Application Priority Data
Sep. 24, 2010 (DE) 10 2010 046 377.9

(51) Int. Cl. F16B 2/12

(52) U.S. Cl. 24/530; 24/568

(57) ABSTRACT

The invention refers to a clamping device and a method for clamping an article, wherein a clamping means connected with the article interacts with clamping elements of the clamping device by a clamping motion for the releasable clamping of the article, and the at least one clamping element can be moved by a clamping drive along a clamping direction, and additionally the clamping element is movable in a compensation direction differing from the clamping direction, in order to allow centering and afterwards clamping of the article.

The invention refers to a clamping device for indirect or direct clamping of at least one article, such as, for example, a work piece or a tool, wherein a clamping means connected indirectly or directly with the article interacts with one or more clamping elements of the clamping device through a clamping motion for releasable clamping of the article.

The invention comprises furthermore also a method for releasable clamping an article, for example a work piece or tool with a clamping device, wherein during a clamping motion at least one clamping element of the clamping device is moved in such a way by a clamping drive along a clamping direction that the at least one clamping element interacts with a clamping means connected indirectly or directly with the article.

### BACKGROUND OF THE INVENTION

Clamping devices as described in the beginning are sufficiently known in the field of work piece machining. A clamping device of this type is expected to hold the work piece absolutely exactly, even if the machining forces act on it. Therefore, clamping devices of this type do not only have to receive appropriate machining forces, but also to keep an appropriately high accuracy during clamping the article. Clamping devices of this type are employed, for example, in machine tools, machining centers, machining stations or the like. In order to prevent error machining or rejects, here a high reproducibility of the clamping parameters (accuracy of positioning, holding forces) is essential. It has to be noted here that the invention does not only deal with clamping work pieces, but the suggestion according to the invention can basically also be employed for clamping any other articles, such as, for example, also tools.

Different concepts have become known for clamping work pieces. The article, for example the work piece, is clamped, for example directly by the clamping device, for this purpose the tool itself carries a clamping means, for example a clamping bolt or the like. However, it is also known to mount the article, for example the work piece, on a pallet, the pallet being equipped with appropriate clamping means, and thus an indirect connection of the article with the clamping device is carried out. All these solutions are part of the field of the invention.

Of course, the clamping device of this type serves for clamping at least one article; in an arrangement of several articles, for example on a pallet, by means of the clamping device of this type also several articles can be clamped simultaneously.

The clamping device has one or more clamping element(s) interacting in an appropriate way with the clamping means that is indirectly or directly connected with the article, and thus accomplish (es) a releasable clamping. The clamping motion is carried out here by at least one clamping element, for the clamping motion an appropriate clamping drive is provided.

In the state of the art so-called zero point clamping systems are known, wherein for example a clamping ring is arranged at the pallet carrying the article or at the article itself, and the clamping device has a cone-like entering mandrel interacting with the appropriate contact surfaces of the clamping ring. Additionally, reference surfaces are provided with which the clamping definitively has to be in contact in order to guarantee thus an exact positioning of the article relatively to the clamping device. Thus several surfaces are in competition during the interaction of the clamping ring, that is the clamping means, with the clamping device, and this position over-definition is undesirable in this respect. The cone-like configuration of the entering mandrel has to be manufactured as exactly as possible in order to guarantee a high reproducibility of the tensioning and holding forces. This leads to an appropriate high effort in the manufacturing of clamping devices of this type.

Furthermore, in the state of the art clamping devices have are known where a cylindrical clamping means interacts with a clamping device. Basically, such a configuration does have free motion, as otherwise approaching these two elements is not possible. However, this free motion must be compensated later with an appropriate high effort.

Usually, the article (in particular the work piece) is held not only by one clamping device but also by several clamping devices. The cylindrical configuration entails an exact putting-in and lifting-out motion of the article on or of the clamping device in order to prevent the article from jamming during putting-in or removing out of the clamping device. Usually, an accuracy that high is not provided during the putting-in or removal motion, or it entails appropriate effort. There is a significant risk of jamming of the article on these clamping devices, which has the consequence that undesired machining breaks occur, or a higher effort is necessary for feeding and removing the article as exactly as possible.

### BRIEF SUMMARY OF THE INVENTION

Therefore it is an object of the invention to improve the clamping device described in the beginning or the also described method of the releasable clamping of an article in such a way that at least one of the mentioned disadvantages is overcome.

In order to solve this problem according to the invention, the invention suggests a clamping device as described in the beginning, wherein the at least one clamping element can be moved by a clamping drive along a clamping direction, and additionally the at least one clamping element can move in a preferably rectangular compensation direction that differs from the clamping direction, in order to allow, in a first step of the clamping motion, before the actual clamping a centering of the article or the clamping means relatively to the clamping device or the at least one clamping element in the direction of compensation.

The method according to the invention suggests for solving this problem that, in a first step of the clamping motion, the at least one clamping element moves in a in particular rectangular compensation direction differing from the clamping direction for centering the article or the clamping means relatively to the clamping direction or the at least one clamping element, and, in a second step following the first step of the clamping motion, the clamping means is clamped by the at least one clamping element, in particular by a motion of the at least one clamping element in the clamping direction.

According to the invention, centering of the article or the clamping means is carried out relatively to the clamping direction or to the at least one clamping element before clamping.

The result is a number of advantages.

The risk of the clamping means jamming during introducing the clamping means in the clamping device is avoided as sufficient free motion can be provided that then, for example in the centering step, will be eliminated. It has to be taken into consideration here that the solutions according to the state of the art provide only one clamping step, and then, in clamped condition, of course, centering is not possible anymore. Possible inaccuracies during positioning then have to be compensated by appropriate measurements, such as, for example, by a springy configuration of the cone or any other expensive solution. This is not necessary anymore according to the inventions.

The suggestion according to the invention also avoids an over-definition of the position, as by the suggestion according to the invention the arrangement of a single, relevant reference surface is possible for the exact positioning of the article relatively to the clamping device. An expensive machining of the clamping means, that is, according to the state of the art, equipped with an appropriate cone, is not necessary in the suggestion of the invention; the reproducibility of the clamping process is very high as there is no separation of the clamping counter forces so that the machining processes become accordingly safe, and the single articles are very equally clamped, that is with the same accuracy and holding force by the clamping device according to the invention by using the clamping method according to the invention.

The suggestion according to the invention allows also a rather large range of collection and thus also a safe gripping of the article by the clamping device.

It has to be noted that the clamping device according to the invention has at least one clamping element, however, usually a variety of clamping elements. All these solutions are comprised by the invention.

The suggestion according to the invention compensates a possible free motion and centers the article relatively to the clamping direction, respectively, by allocating a certain mobility to the clamping element. Usually, the clamping drive serves for moving the clamping element in the clamping movement along the clamping direction, and thus for accomplishing a clamping with a releasable fixed connection. According to the invention, however, the clamping element has an additional mobility in the compensation direction orientated with reference to the clamping direction preferably rectangular, however, at least not congruent with it. This free mobility or this degree of freedom is used for centering. This is the difference between the clamping method and conventional known methods, where centering, that is alignment of the article relatively to the clamping direction, is not provided, and, after clamping, the position cannot be changed anymore.

In the development according to the invention it is provided that there is a certain free mobility of the at least one clamping element in compensation direction. The free mobility here is only a few 1/10 mm or 1/100 mm. These dimensions must not be understood as limiting, depending on the construction they can be chosen even larger or smaller.

Therefore, the suggestion according to the invention provides that the clamping element does not only carry out a motion in the direction of clamping, that is for introducing an appropriate high clamping power for holding the article, but that the clamping element has also a certain mobility along the compensation direction. Therefore it is convenient that there is no rigid coupling or connection of the at least one clamping element with the clamping drive as the clamping drive is responsible for the main clamping motion in the direction of clamping. However, cleverly the motion of the clamping element in compensation direction is derived from the clamping drive, and thus the clamping drive is used multiple.

It is seen as advantageous, if the clamping device is configured in such a way that here an engaging or applying of the clamping element on or to the clamping means is carried out section by section. The result is, in the course of the clamping movement, first of all, a centering of the clamping means by the clamping element, and, after that, in a second step of the clamping motion, a clamping of the article by the clamping device or the motion of the clamping drive. Both steps of the clamping motion are defined, among others, over the engagement or the application of the clamping element on or to the clamping means. These may be two separate movements, however, they are carried out continuously one after the other. Thus, centering the clamping means goes over through the guided motion of the clamping element in the clamping of the article, which has to be understood as second step of the clamping motion. Thus, the clamping element takes, first of all, a centering position in order to get then, for example by a shaping provided at the clamping means, in a continuous motion of the clamping device or the clamping elements and clamping element aids arranged there mobile in a clamping position, and to clamp the clamping means.

In connection with the before described motion or way of function of the clamping device according to the invention, it is seen as convenient, if the clamping means has an appropriate shaping, and thus exercises a control function on the clamping element engaged with the clamping means. For that the clamping means has at least one recess, undercut or notch that allows a positive locking interaction with the at least one clamping element or its parts. After introducing the clamping means in the clamping device, and on operating the clamping device the clamping element is put in an appropriate recess, undercut, notch or the like at the clamping means, and approaches it positive locking. This leads, first of all, to a centering of the clamping means in the clamping device, via the clamping element engaged or in positive locking interaction with the clamping means. Further operating the clamping device, via the appropriate shaping of the recess, undercut, notch or the like, entails in the clamping means a guiding of the clamping element that eventually has the effect that, when the clamping motion is finished, clamping of the clamping means and the connected article is carried out.

For that the shaping of the clamping means effects an approach of the clamping element to a contact position during fixing or clamping the clamping means.

In order to execute the clamping function, a preferred embodiment of the clamping device provides that there is a receiving opening for receiving the clamping means. In this receiving opening then the clamping element(s) is/are arranged. These may be arranged in the receiving opening annularly or collar-like. After introducing the clamping means in the receiving opening and following operating of the clamping device the clamping elements are moved radial in the direction of the clamping means, and interact with them, in particular positive locking in order to effect centering or clamping of the article or the clamping means arranged there relatively to the clamping direction.

In another preferred embodiment of the clamping device also comprised by the invention it is provided that the clamping device has an entering mandrel on the outer surface of which the clamping elements are arranged. This entering mandrel extends from a support for the article, and engages in an appropriate recess or receiving opening at the article or a receiver for the article. The clamping elements that then interact with a clamping device designed in the shape of a receiving opening at the article or the support for the article, are here arranged annularly at the entering mandrel, for example at its outer surface. The clamping means, configured for example as receivers, have for that an annularly or ring groove-like designed clamping means. Here also, first of all, a motion of the clamping element in a preferably rectangular compensation direction different from the actual clamping direction is carried out by a clamping drive in order to center the article in a first step of the clamping motion before the actual clamping of the article or the clamping means relatively to the clamping device, before then the article is clamped. In the before-mentioned case the clamping means at the article does not need to be necessarily designed as receiving opening. There is rather the chance of providing here clamping means shaped in the way of a bush to overlap the clamping device with the clamping elements at an entering mandrel.

The clamping device of the present invention thus comprises altogether the configuration of the clamping device designed for receiving a clamping, means as well as also the reversed solution where the clamping device is configured in the way of an extending or projecting element, for example as entering mandrel or the like, and engages in an appropriate opening or receiving opening at the article or the pallet carrying the article or the like. This embodiment of the clamping device according to the invention then has the same way of functioning as the clamping device configured as receiver altogether. It is an advantage of an embodiment of this type that there are no indentations or the like at the clamping device where dirt, chips or the like can be deposited that then impede the operation of the clamping device. Also the configuration of a corresponding recess at the article or at an element of the machine receiving the article is very easy, as here only an appropriate boring has to be arranged. This can be executed with appropriate precision and is significantly less prone to damages or wear than a bolt protruding for the article from the article or the receiver, or a clamping means designed in any other way.

The article may be, as already mentioned several times before, a work piece to be machined that is equipped with appropriate clamping means, for example clamping bolts or recesses for an engagement with the clamping device, however, the clamping device according to the invention can also be used for clamping tools. Besides, there is, of course, here also the possibility that via the clamping device a pallet or the like is clamped on a machine tool that then serves for receiving the work pieces to be machined.

In an embodiment of the clamping device seen as advantageous this has a receiving opening for receiving the clamping means. In order to prevent chips or other dirt, dust or cooling liquid and lubricant, respectively, from penetrating, if one or more clamping devices are not employed for receiving clamping means, it is provided, according to the invention, that a closure cap seals the receiving opening. This closure cap is pressed in the receiving opening preferably against the power of a spring, in particular by the clamping means introduced in the receiving opening, and thus releases the receiving opening. If the clamping means is removed from the receiving opening the restoring force of the spring effects that the closure cap is shifted within the receiving opening into a closure position, and thus seals the receiving opening tightly. For that, the closure cap may have additional sealing elements that slide along the walls of the receiving opening, and, after that, improve further sealing of the upper side of the receiving opening.

The invention comprises embodiments of the clamping device for receiving a clamping element as well as also accordingly clamping devices designed in opposite direction that are configured as protruding or extending mandrel or the like, and are introduced in a recess or receiving opening at the article. The clamping means provided in an appropriate clamping device are therefore designed preferably as clamping bolts for introducing in a receiving opening or as clamping ring or clamping bush or sleeve for receiving a clamping device designed as entering mandrel. In any case, the clamping means have a shaping that allow and can control the clamping motion according to the invention, that is guiding and moving the clamping elements.

The clamping drive allocated to the clamping device can have a variety of possible embodiments. Thus, this clamping drive may be configured acting as an electro motor, electro-mechanically, pneumatically, mechanically, or hydraulically. At the same time, there is the chance here of combining several suitable way of drive to coordinate the single series of motions within the clamping device. If, for example, a mechanic clamping drive is provided because of a spring or a spring assembly, this spring then can, for example, again be relaxed by an accordingly arranged hydraulic system to release the clamping means. The clamping drive allocated to the clamping device according to the invention in a preferred embodiment comprises preferably a tie sleeve or a tie bolt. This is moved by the clamping drive and acts here on the clamping element because of its configuration, and moves it. It turns out here as advantageous, if the tie sleeve or the tie bolt holds the at least one clamping element cage-like. The tie sleeve or the tie bolt can be moved via the clamping drive in the direction of clamping, wherein the tie sleeve or the tie bolt is then configured in such a way that moving of the at least one clamping element is possible in the direction of compensation. Thus the clamping element is arranged moving, at least within the above mentioned limits, in the tie sleeve or the tie bolt, and by means of this thus it can be moved over the profile given, for example, by the clamping means or the like, in order to take over, on the one hand, a centering function, and, on the other hand, a clamping function that are provided in steps of the clamping motion following one after the other in the clamping device according to the invention.

In the clamping device according to the invention the clamping element provided here takes over, as already explained, a double function. First of all, via the clamping element the clamping means interacting with the clamping device is centered, in order to then interact with the article in the course of a clamping motion for the releasable clamping of the article. The clamping element is here preferably configured as clamping ball or clamping jaw. However, all other possible and suitable embodiments of the clamping element are possible, the present invention comprising and including, respectively, all such clamping elements. For example, the clamping element may be configured as moving bolt or pin as well as a cylinder, cone or the like to interact with the clamping means, for example a clamping bolt or a clamping ring.

The configuration of the clamping device according to the invention is not limited to the embodiment with clamping elements of one of the before mentioned types. There is rather the chance of arranging several types of clamping elements that may be designed differently, in one and the same clamping device. The appropriate clamping element can be chosen here depending on the intended function in the clamping device according to the invention. Thus, for example, a ball-like configured clamping element can be used for centering the clamping means, while after that this first clamping element is exchanged or completed by another clamping element with another embodiment, for example a clamping jaw or the like, to carry out finally clamping of the clamping means or the article in or at the clamping device. Thus the clamping element can also be used configured in two or more pieces in the clamping device according to the present invention. This configuration is also comprised by the invention. In any case the problem according to the invention is also solved by the appropriate embodiment of the clamping device with two or more, if necessary differently configured, clamping elements, and the construction of a clamping device is improved considerably. In any case, a clamping means connected indirectly or directly with the article interacts with one or more of the, if necessary, differently designed clamping elements of the clamping device by a clamping motion for a releasable clamping of the article. Here, the at least one clamping element in a first embodiment is moved along a clamping direction by a clamping drive, and additionally another clamping element, if necessary differing from the previous one, is centered in a preferably rectangular compensation direction differing from the clamping direction. The clamping element provided in the clamping device thus has not to be seen as an only element, but as a functional component of the clamping device with single elements that have, if necessary, different configurations that add up to the clamping element of the clamping device.

In an embodiment of the clamping device seen as favorable a supporting element is provided on the side of the at least one clamping element opposite the receiving opening. The supporting element surrounds in particular the ring- or collar-like arranged clamping elements, for example in the way of a sleeve. The clamping element(s) are supported during a part of the clamping motion on the supporting element that has a configuration through which the clamping element is shifted during its motion in the clamping direction also in the compensation direction towards the clamping means. The supporting element thus provides a guide for the clamping element, and thus effects partly the way of function of the clamping device according to the invention. The guide at the supporting element, that is configured, for example, in the shape of a projection or shoulder, effects during the motion of the clamping element, for example by shifting the tie sleeve or the tie bolt, a radial motion of the clamping element towards the clamping means, and thus shifts the clamping element in a recess, undercut, notch, or the like provided at the clamping means, in order to carry out thus a centering of the clamping means in a first step of the clamping motion. In the further course the supporting element leads the clamping element accordingly further, in particular within the shape of the recess or the like defined by the clamping means, to allow eventually the second step of the clamping motion where clamping of the clamping means or the article in clamping direction is carried out, the clamping element being additionally supported by the clamping means and clamping it.

The clamping device according to the invention provides in a preferred embodiment that the supporting element is configured essentially sleeve-like. The clamping element is supported here depending on the respective configuration of the clamping device according to the invention on the inner surface of the sleeve of the supporting element or on its exterior surface. The interior surface of the sleeve or its exterior surface has here a relief or cone designed in the way of a shoulder or the like by which the at least one clamping element during its motion in clamping direction is shifted, first of all, in the direction of compensation toward the clamping means. The shoulder or cone allows a guide of the clamping element. This is introduced by the respective embodiment of the support element either in a recess provided, for example, in the clamping means, or in an annular clamping means in which, for example, a clamping device configured as bolt or the like projects, in the annular clamping means provided there to cause centering. In the further course the support element then has a reduced inner diameter of the sleeve or an enlarged outer diameter of the sleeve, so that then the clamping element is held in an appropriately before defined position during its motion in clamping direction, so that the clamping means remains centered during the entire motion. As the clamping device according to the invention comprises both before mentioned alternatives of the embodiment, the respectively chosen embodiment also defines the shaping and arrangement of the support element.

A preferred embodiment of the clamping device avoids the disadvantages of the before mentioned state of the art with reference to an over-definition of the surface in that in the area of interaction of the at least one clamping element with the clamping means no reference surfaces have to be provided for exact positioning of the article relatively to the clamping device to accomplish nevertheless an exact positioning as well as a consecutive clamping of the article. The clamping device according to the invention thus allows an essentially simpler construction while improved technical values are accomplished. The clamping device according to the present invention thus combines the function of centering the article with the clamping in a single operation or a single element of the device.

The invention also comprises a method for the releasable clamping of an article, for example a work piece or tool by means of a clamping device. The clamping device is here configured in particular as described above. The method according to the invention provides that during a clamping motion at least one clamping element of the clamping device is moved by a clamping drive along a clamping direction in such a way that the at least one clamping elements interacts with a clamping means connected indirectly or directly with the article. The method according to the invention is characterized here in that in a first part of the clamping motion the at least one clamping element moves in a in particular rectangular compensation direction different from the clamping direction. This causes centering of the article or the clamping means relatively to the clamping device, and, after tat, in a second part of the clamping motion following the first part the clamping means is clamped by the at least one clamping element, in particular by moving of the at least one clamping element in clamping direction. Here, in a first part of the clamping motion the clamping element engages preferably with the clamping means positive locking, and effects in the course of the positive locking interaction of clamping element and clamping means in the course of the clamping motion in clamping direction clamping of the article. It is provided in the method according to the invention that, before the first part of the clamping motion, the at least one clamping element is moved in clamping direction. In the course of this motion in clamping direction then, basing on the before-mentioned embodiment of the clamping device employed in the method according to the invention a simultaneous moving of the clamping element in a compensation direction different from the clamping direction. The motion provided in the method according to the invention is continuous, that is the motion of the clamping element in compensation direction changes into a motion in clamping direction.

The method according to the invention comprises here, with reference to the compensation direction, a radial motion of the clamping element towards the center of the clamping device, as well as away from it. The motion of the clamping element depends here on the respective configuration of the clamping device employed in the method according to the invention and the position and shaping of the clamping means, respectively.

The invention also comprises a processing machine that has for clamping of at least one article one or more of the before described clamping device(s). Without restricting the invention to it, the processing machine may be, for example, a metal-cutting machining tool, a machining center, or a working station of a machining line or processing line. Here, of course, also the arrangement of several appropriate clamping devices can be provided at single positions of the machining center or the single working stations of a machining line or a machining street. All before-mentioned embodiments of the processing machine are comprised by the present invention. Besides the use of the clamping device according to the invention in one of the before-described processing machines, of course, also a receiving element, for example a pallet or a supporting table, for receiving articles to be machined, can be equipped with the clamping device according to the invention. Arranging the clamping device in a spindle receiving a tool or the like is also provided here. Because of the fact that the clamping device allows an exactly positioned centering and a following clamping of the article, the clamping device is suited, for example, also for the use in the tool mounting of a lathe or the like working with a stationary metal-cutting tool that is angled against a rotating tool. The advantages of the exact positioning of the tool and the clamping forces that can be accomplished through the clamping device are proof that the clamping device is suited for the described purposes.

In this connection it is in particular pointed out that all characteristics and features, but also methods, described in connection with the device can be transferred accordingly also with reference to the formulation of the method according to the invention, and can be employed according to the invention, and have to be seen also as disclosed. The same goes also vice versa, that means constructive, that is device, characteristics mentioned only with respect to the method can also be taken into consideration and be claimed in the frame of the device claims, and count also as part of the invention and disclosure.

### BRIEF DESCRIPTION OF THE DIFFERENT VIEW OF THE DRAWINGS

In the drawing the invention is shown schematically, in particular in an embodiment. In the figures:

FIGS. 1 to 4 a preferred embodiment of the clamping device according to the invention in different positions of clamping and centering, respectively, each in a side section view.

In the figures identical or corresponding elements each are indicated by the same reference numbers, and therefore are, if not useable, not described anew.

### DETAILED DESCRIPTION OF PREFERRED EMBODIMENTS

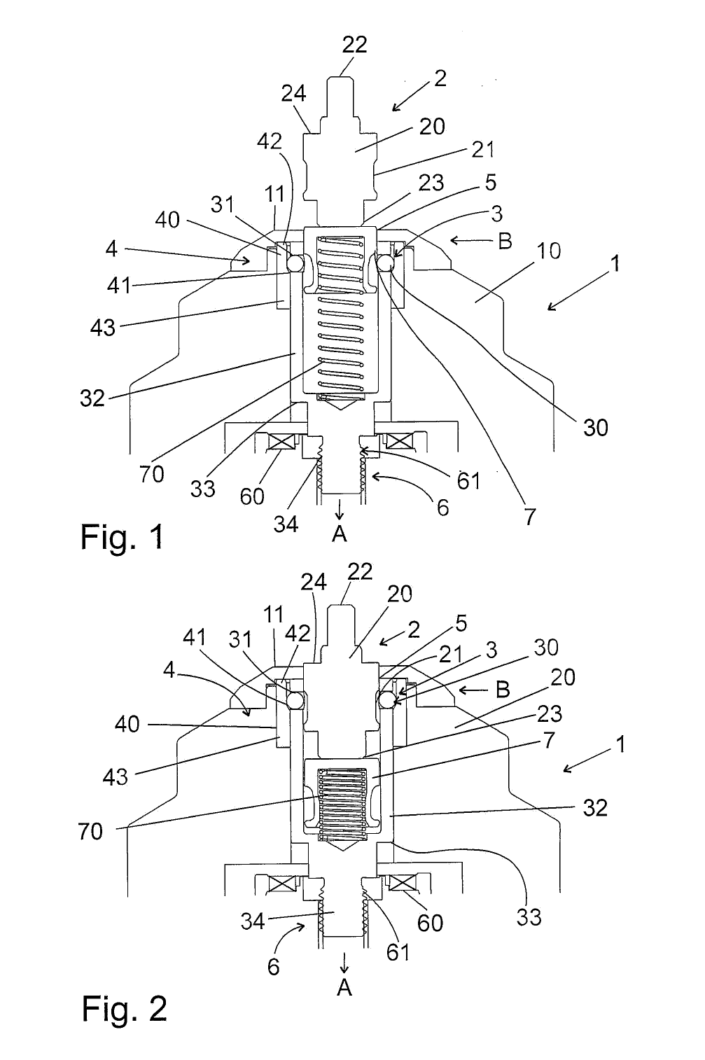

FIG. 1 shows a preferred embodiment of the clamping device 1 according to the invention. This comprises a clamping element 3 as well as a clamping drive 6. A clamping means 2 is allocated to the clamping device 1, the clamping means 2 may be arranged, for example, at an article, such as for example a tool, a work piece, a pallet or a supporting table for an article or a work piece, and, engaged with the clamping device 1, serves for clamping the article for machining. The clamping device 1 itself has a basic body 10, that is arranged, for example, on a supporting table (not shown), and has inside the clamping device 1. The basic body 10 provides additionally the receiver for the clamping drive 6. In the basic body 10 there is also the receiving opening 5 through which the clamping means 2 can be introduced in the clamping device 1. In the receiving opening 5 there are all parts of the clamping device 1. These are, for example, the supporting element 4, the clamping element 3, and the clamping drive 6. The receiving opening 5 is sealed by a closure cap 7 that can be shifted within the receiving opening 5 or the clamping device 1 against the power of a spring 70. When the clamping device 1 is not used, that is without received clamping means 2, the closure cap 7 seals the receiving opening 5 tightly.

In FIG. 1 the clamping means 2 is shown before it is introduced in the receiving opening 5. The clamping means 2 is here supported on the closure cap 7. If necessary, the closure cap 7 can have appropriate marks to be able to carry out here already a pre-centering of the clamping means 2. During introducing the clamping means 2 in the receiving opening 5 the spring 70 is compressed by the closure cap 7 that is shifted in the receiving opening 5. The spring 70 is shown in FIGS. 2, 3 and 4 in compressed condition. After removing the clamping means 2 through the restoring force of the spring 70 the closure cap 7 is returned in its closing position in the clamping device 1 and seals the receiving opening 5, so that dirt or the like is prevented from penetrating. A blowing device, that is not shown in FIGS. 1 to 4, can be allocated to the closure cap 7 and the receiving opening 5, respectively, the blowing device blowing appropriate material, such as, for example, chips, dust or even lubricants or cooling liquids used in the course of machining work pieces out of the clamping device 1, and avoids here excessive soiling.

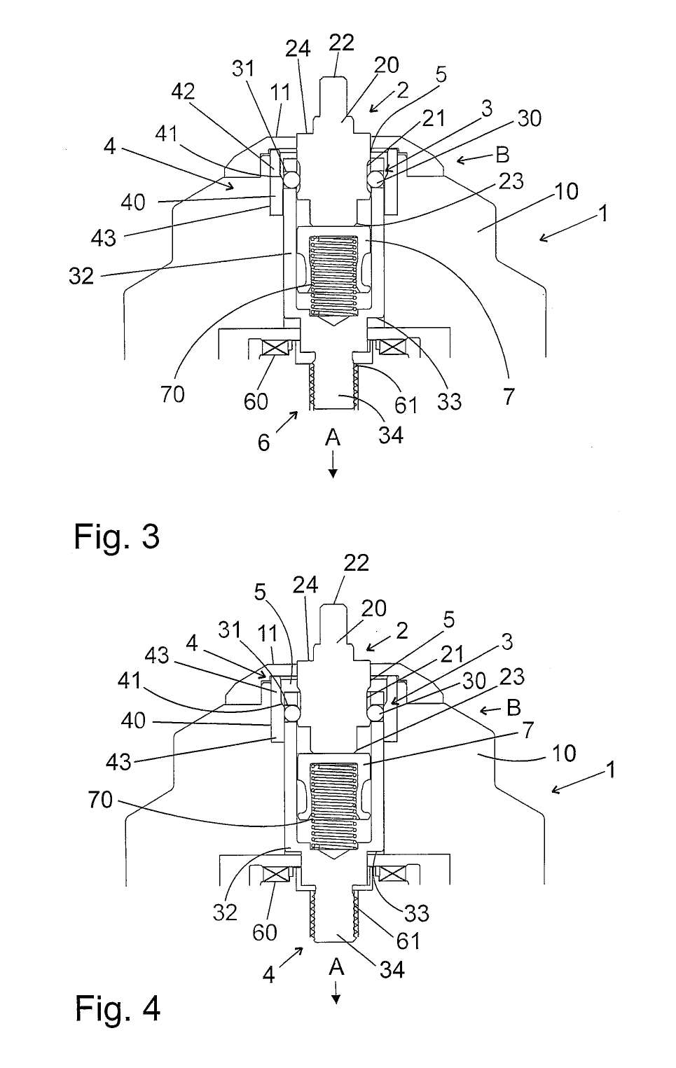

The clamping device 1, as shown in FIGS. 1 to 4, furthermore comprises a clamping element 3. This is configured in the shown example as ball 30. During operating the clamping device this clamping element 3 takes over a double function. On the one hand, the clamping element 3 effects a centering of the clamping means 2, on the other hand, the clamping element 3 allows clamping of the clamping means 2 in the clamping device 1. During the clamping operation the clamping element 3 carries out two motions altogether in different directions. First of all, after putting in the clamping means 2 in the clamping device 1 and initiating the clamping process, the clamping means 2 is moved in a preferably rectangular compensation direction (B) different from the clamping direction (A). This motion effects, as shown in the embodiment of FIGS. 2 and 3, that the ball 30 engages positive locking in a recess 21 provided at the clamping means 2. During this engaging centering of the clamping means 2 in the receiving opening 5 is carried out. Thus an exact positioning of the clamping means 2 is carried out already shortly after introducing in the receiving opening 5 and putting into operation of the clamping device 1. In order to be able to engage in the recess 21 the ball 30 is supported moving. A cage 31 provided in a tie sleeve 32 also provided in the clamping device 1 and serving as mount for the ball 30 serves as bearing for the ball. The tie sleeve 32 provides at its sleeve bottom 33 a receiver for the spring 70. Thus the spring 70 is impinged during the shifting of the closure cap 7 against the sleeve bottom 33. On the opposite side, the sleeve bottom 33 has a threaded bolt 34 interacting with the clamping drive 6, and through which the tie sleeve 32 then is shifted in the clamping direction (arrow A). During this shifting of the tie sleeve 32 the motion of the clamping element 3, in the embodiment ball 30, is carried out. The ball 30 received in the cage 31 arranged at the tie sleeve 32 is guided by the motion of the tie sleeve 32 along the inside of the sleeve 40. The interior surface of the sleeve 40 has an upper sleeve section 42 and a lower sleeve section 43. The upper sleeve section 42 has a reduced wall thickness compared with the lower sleeve section 43. Therefore, the sleeve 40 has a shoulder 41 serving as guide for the ball 30. The ball 30 slides in the course of the shifting of the tie sleeve 32 along the interior surface of the sleeve 40, and is shifted by the projecting shoulder 41 in the direction of the clamping means 2, that is configured in the example as clamping bolt 20, in a compensation direction (B) differing from the clamping direction (A) towards the clamping bolt, and is pressed into the recess 21 provided in the clamping bolt 20 so that here a positive locking engaging takes place. Further shifting of the tie sleeve in the clamping direction (A) shifts the ball 30 in the recess 21 in clamping direction (A), and until the bottom end of the recess 21. Further shifting of the tie sleeve 32 is then accomplishes clamping of the clamping bolt 20 in the clamping direction.

The clamping device 1 is at its top end sealed by a lid 11. This is supported on the basic body 10, and seals the clamping device arranged in the basic body 10. A recess corresponding with the receiving opening 5 is arranged in the lid 11. If a clamping means 2 is put in the clamping device 1 and clamped, its boundary layer 24 is even with the lid 11. The bottom end 23 of the clamping means 2 is here supported on the closure cap 7 while at the upper end 22 a connection of the clamping means 2 with an article is possible. The upper end 22 of the clamping means 2 is only shown schematically in the drawings. Here, for example, threads or the like can be arranged for fastening the clamping bolt 20 to the article.

In the shown example an electro motor causing the shifting motion of the tie sleeve 32 is used as clamping drive 6. The clamping drive 6 is run rotating on bearings below the clamping device 1 relatively to the basic body and the clamping device 1 arranged in it. For that appropriate bearings 60 are arranged. The thread 61 provided at the threaded bolt 34 engages in the clamping drive 6 so that, depending on the rotational direction of the clamping drive 6 a shifting of the tie sleeve 32 in the clamping direction (A) or opposite this direction occurs to carry out clamping or releasing of the clamping means 2 in or from the clamping device 1.

FIGS. 1 to 4 only show a possible embodiment of the clamping device according to the invention. This has a receiving opening 5 for receiving a clamping means 2, wherein the elements of the clamping device 1 are arranged in the interior of the receiving opening 5 to interact with the clamping means 2 driven via the clamping drive 6. Besides the embodiment shown here there is also, of course, the possibility of configuring the clamping means 2, for example as sleeve. The clamping device 1 then has an exactly reversed construction, that means the clamping element 3 moves by means of the tie sleeve 32 and guided by the shoulder 41 in the sleeve 40 not radial towards the center of the receiving opening 5, but away from this center in radial direction, to get engaged with an appropriate recess, that is provided in the sleeve forming the clamping means 2, and to carry out a centering.

Besides the embodiment of the clamping device described before there is, of course, the possibility of arranging all elements of the clamping device 1 on a not-shown entering mandrel that then is introduced in a mount, for example for a work piece or a tool, arranged at the article or a pallet or elsewhere. The way how the clamping device 1 works remains the same here. Here also a clamping means 2, such as, for example, a clamping ring or the like provided in the article, connected with the article indirectly or directly interacts with one or more clamping elements 3, such as, for example, balls, bolts, pins, or cylinders of the clamping device 1 by a clamping motion for releasable clamping of the article. The at least one clamping element 3 is here mobile by a clamping drive 6 along a clamping direction (A), and additionally in a preferably rectangular compensation direction (B) differing from the clamping direction (A). This movement leads in this case the clamping element 3 radial away from the center of the clamping device 1, and presses it in a recess, ring groove or the like provided at the clamping means 2. In a first step of the clamping motion, that is before the actual clamping, via this radial motion of the clamping element 3 the article or the clamping means 2 is centered relatively to the clamping device 1. In the further course of the clamping motion then the clamping means 2, that is the article, is clamped together with the clamping device 1, that immerses in the course of the continued clamping motion deeper in the receiving opening 5 at the article, and eventually clamps clamping device 1 together with the article. The invention thus comprises clamping devices 1 for receiving clamping means 2 as well as clamping devices 1 for introducing in an article to be clamped that then provides the clamping means 2, and interacts with the clamping elements 3 of the clamping device 1.

In FIGS. 1 to 4 schematically a clamping drive 6 in the example of an electro motor drive is shown. Besides, there is, of course, the possibility of configuring this clamping drive 6 as acting pneumatically, electro mechanically, mechanically for example because of a spring or a spring assembly, or hydraulically. There is also the possibility of combining different drive modifications so that, for example, if a mechanic clamping drive 6 by means of a spring or a spring assembly a hydraulic system is used, for relaxing the spring a hydraulic system is employed.

The claims filed with the application now and to be filed later on are attempted formulations without prejudice for obtaining a broader protection.

If here, on closer examination, in particular also of the relevant prior art, it turns out that one or the other feature may be convenient for the object of the invention, however, not decisively important, of course, of course, already now a formulation is striven for which does not contain anymore such a feature, in particular in the main claim.

Furthermore, it has to be taken into consideration that the embodiments and modifications of the invention described in the different examples and shown in the figures can be combined with each other in any way. Here single or several characteristics can be exchanged at will. These combinations of characteristics are also disclosed.

References in the sub-claims relate to the further design of the matter of the main claim through the characteristics of the respective sub-claim. These are, however, not to be understood as a waiver of independent subjective protection of the matter for the characteristics of the referred sub-claims.

Characteristics only disclosed in the description so far may now, in the course of proceedings, be claimed as being of inventive relevance, for example to distinguish from the state of the art.

Characteristics only disclosed in the description or even single characteristics of claims comprising a number of characteristics may now be taken over in the first claim at any time to distinguish from the state of the art, and this is even if such characteristics have been mentioned in connection with other characteristics, and achieve particularly convenient results in connection with other characteristics, respectively.

1. Clamping device for indirectly or directly clamping at least one article, such as, for example, a work piece or tool, wherein a clamping means connected indirectly or directly with the article interacts with one or more clamping elements of the clamping device by a clamping movement for releasable clamping of the article, and the at least one clamping element can move by a clamping drive along a clamping direction, and additionally the at least one clamping element can move in a preferably rectangular compensation direction differing from the clamping direction to allow in a first step of the clamping motion, before the actual clamping, centering of the article or the clamping means relatively to the clamping device or the at least one clamping element in the direction of compensation, wherein free motion of the at least one clamping element is provided in compensation direction, in particular wherein the clamping element is designed as clamping ball or clamping jaw, and/or the clamping device has also several types of clamping elements each configured differently, and the different types of clamping elements serve for different purposes, for example a first type of clamping elements for centering and a second type of clamping elements for clamping.

2. Clamping device according to claim 1, wherein a non-rigid coupling or connection of the at least one clamping element with the clamping drive is provided.

3. Clamping device according to claim 1, wherein clamping an article by the clamping device is provided only after centering in a second step of the clamping motion, and wherein clamping the article by the clamping device is carried out only after centering in the second step of the clamping motion.

4. Clamping device according to claim 1, wherein the clamping means has at least one recess, undercut, notch or the like for an in particular positive interlocking with the at least one clamping element.

5. Clamping device according to claim 1, wherein the clamping device has a receiving opening for holding the clamping means, and wherein the clamping elements surround the receiving opening annularly or collar-like.

6. Clamping device according to claim 1, wherein the clamping device has an entering mandrel on the outer surface of which the clamping elements are arranged, and wherein the entering mandrel engages in an annularly configured clamping means.

7. Clamping device according to claim 1, wherein a closure cap is provided that seals the receiving opening and that can be pushed against the force of a spring, in particular through the clamping means in the receiving opening, and wherein the closure cap seals the receiving opening and can be pushed against the force of a spring, in particular through the clamping means in the receiving opening, and thus releases it for holding the clamping means.

8. Clamping device according to claim 1, wherein the clamping means is configured as clamping bolt or clamping ring.

9. Clamping device according to claim 1, wherein an electro-motor clamping drive, or an electro-mechanically, pneumatically, mechanically (for example because of a spring or a spring assembly), or hydraulically acting clamping drive is provided.

10. Clamping device according to claim 1, wherein the clamping drive comprises a tie sleeve or a tie bolt that is moved by the clamping drive, and wherein the tie sleeve or the tie bolt acts on the at least one clamping element and moves it/them.

11. Clamping device according to claim 1, wherein the clamping drive comprises a tie sleeve or a tie bolt that is moved by the clamping drive, and wherein the tie sleeve or the tie bush holds the at least one clamping element cage-like, and the tie sleeve or the tie bolt can be moved in the clamping direction, and the at least one clamping element has mobility in the compensation direction.

12. Clamping device according to claim 1, wherein a supporting element is provided on the side of the at least one clamping element opposite the receiving opening, wherein in particular the supporting element surrounds the annularly or collar-like arranged clamping element sleeve-like, and the clamping element is supported on it during at least a part of the clamping motion, and the supporting element has a configuration through which the clamping element during its motion in clamping direction is shifted also in compensation direction towards the clamping means.

13. Clamping device according to claim 1, wherein a configuration of the supporting element is provided as sleeve with an interior surface of the sleeve and a relief or a cone arranged in the sleeve, and wherein the at least one clamping element is supported on the interior surface of the sleeve of the supporting element, and the at least one clamping element is shifted during its motion in clamping direction also in compensation direction towards the clamping means by the relief or cone in the sleeve.

14. Clamping device according to claim 1, wherein in the area of interaction of the at least one clamping element with the clamping means no reference surface for the exact positioning of the article relatively to the clamping device is provided.

15. Method for the releasable clamping of an article, for example a work piece or tool, with a clamping device, in particular according to one or more of the preceding claims, wherein during a clamping motion at least one clamping element of the clamping device is moved by a clamping drive along a clamping direction in such a way, that the at least one clamping element interacts with a clamping means connected indirectly or directly with the article, wherein in a first step of the clamping motion the at least one clamping element moves in a in particular rectangular compensation direction differing from the clamping direction, for centering the article or the clamping means relatively to the clamping direction, and in a second step following the first step of the clamping motion the clamping means is clamped by the at least one clamping element, in particular by a motion of the at least one clamping element in clamping direction.

16. Method according to claim 15, wherein before the first step of the clamping motion, the at least one clamping element is moved in clamping direction.
